(19) United States
(12) Patent Application Publication
(10) Pub. No.: US 2002/0139631 A1
(43) Pub. Date: Oct. 3, 2002

(54) Frictionless rear hub sprocket and ratchet assembly

(76) Inventor: Ming Theng Wang, Taipei (TW)

Correspondence Address: Ming Theng Wang, PO Box 82-144, Taipei, TW

(21) Appl. No.: 09/820,829

(22) Filed: Mar. 30, 2001

(51) Int. Cl. F16D 41/30

(52) U.S. Cl. 192/64; 192/46

(57) ABSTRACT

A frictionless rear hub sprocket and ratchet assembly includes a sprocket fastened to the rear hub of the bicycle and coupled to the chain on the chain wheel of the bicycle, the sprocket having a plurality of internal teeth, a wheel concentrically disposed within an inner diameter of the sprocket, the wheel having equiangularly spaced pairs of stop elements, a ratchet mounted within the inner diameter of the wheel, and a plurality of pawls respectively pivoted to the wheel at one side and respectively disposed between two stop elements of each pair of the stop elements at the wheel, wherein when the sprocket does no work or is rotated clockwise, or when the ratchet does no work or is rotated counter-clockwise, the pawls do not engage the internal teeth of the sprocket and the external teeth of the ratchet, and the sprocket and the ratchet can be respectively rotated relative to each other; when the sprocket is rotated counter-clockwise or the ratchet is rotated clockwise, the pawls are respectively forced into engagement with the internal teeth of the sprocket and the external teeth of the ratchet, causing the ratchet and the sprocket to be rotated synchronously.

### BACKGROUND OF THE INVENTION

The present invention relates to a rear hub sprocket and ratchet assembly for bicycle and, more particularly, to a frictionless rear hub sprocket for bicycle.

A rear hub sprocket and ratchet assembly to which the present invention pertains is designed for use in the rear wheel of a bicycle and coupled to the chain on the chain wheel of the bicycle. When the bicycle rider propels the pedals to rotate the chain wheel forwards, the rear hub sprocket and ratchet assembly is rotated forwards, and therefore the rear wheel is rotated in the same direction. On the contrary, when the sprocket of the rear hub sprocket and ratchet assembly does no work or is rotated backwards, the sprocket does not drive the ratchet, and therefore the sprocket does not rotate the rear wheel at this time.

FIG. 4 shows a rear hub sprocket and ratchet assembly according to the prior art. This structure of rear hub sprocket and ratchet assembly comprises a sprocket A, a ratchet B concentrically disposed within the inner diameter of the sprocket A. a plurality of stop elements A1 equiangularly spaced within the inner diameter of the sprocket A, a plurality of paws C turned about respective pivots C1 pivoted within the inner diameter of the sprocket A, and a plurality of torsional springs D respectively mounted on the pivots C1. The torsional springs D each have two ends respectively stopped at the peripheral wall of the inner diameter of the sprocket A and the stop elements A1. The torsional springs D force the pawls C into engagement with the external teeth B1 of the ratchet B. When rotating the sprocket A counter-clockwise, the pawls C are engaged with the external teeth B1 of the ratchet B, thereby causing the ratchet B to be rotated with the sprocket A. When the sprocket A is stopped, the ratchet B is forced by inertial force to continuously rotate counter-clockwise in idle (because the external teeth B1 are not meshed with the pawls C at this time). If the sprocket A is rotated clockwise, it runs idle without rotating the ratchet B. Because the external teeth B1 of the ratchet B are moved over the pawls C when the ratchet B runs idle, or the pawls C are moved over the external teeth B1 of the ratchet B when the sprocket A runs idle, much noise and friction resistance is produced during idle running of the rear hub sprocket and ratchet assembly.

### SUMMARY OF THE INVENTION

The present invention has been accomplished to provide a rear hub sprocket and ratchet assembly, which eliminates the aforesaid problems. It is the main object of the present invention to provide a rear hub sprocket and ratchet assembly, which does not produce friction resistance or noise when running idle. To achieve this and other objects of the present invention, a frictionless rear hub sprocket and ratchet assembly is provided comprised of a sprocket fastened to the rear hub of the bicycle and coupled to the chain on the chain wheel of the bicycle, the sprocket having a plurality of internal teeth, a wheel concentrically disposed within an inner diameter of the sprocket, the wheel having equiangularly spaced pairs of stop elements, a ratchet mounted within the inner diameter of the wheel, and a plurality of pawls respectively pivoted to the wheel at one side and respectively disposed between two stop elements of each pair of the stop elements at the wheel, wherein when the sprocket does no work or is rotated clockwise, or when the ratchet does no work or is rotated counter-clockwise, the pawls do not engage the internal teeth of the sprocket and the external teeth of the ratchet, and the sprocket and the ratchet can be respectively rotated relative to each other; when the sprocket is rotated counter-clockwise or the ratchet is rotated clockwise, the pawls are respectively forced into engagement with the internal teeth of the sprocket and the external teeth of the ratchet, causing the ratchet and the sprocket to be rotated synchronously.

### BRIEF DESCRIPTION OF THE DRAWINGS

FIG. 1 is a plain view of a frictionless rear hub sprocket and ratchet assembly according to the present invention.

FIG. 2 is a plain view showing the sprocket rotated counter-clockwise, the pawls forced into engagement with the internal teeth of the sprocket and the external teeth of the ratchet according to the present invention.

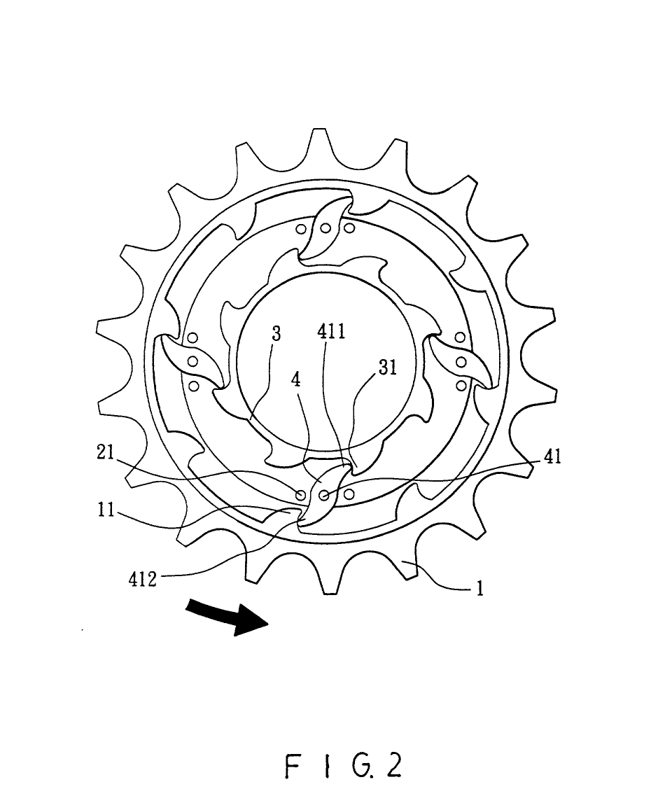

FIG. 3 is a plain view showing the ratchet rotated clockwise, the pawls forced into engagement with the internal teeth of the sprocket and the external teeth of the ratchet according to the present invention.

FIG. 4 is a plain view of a rear hub sprocket and ratchet assembly according to the prior art.

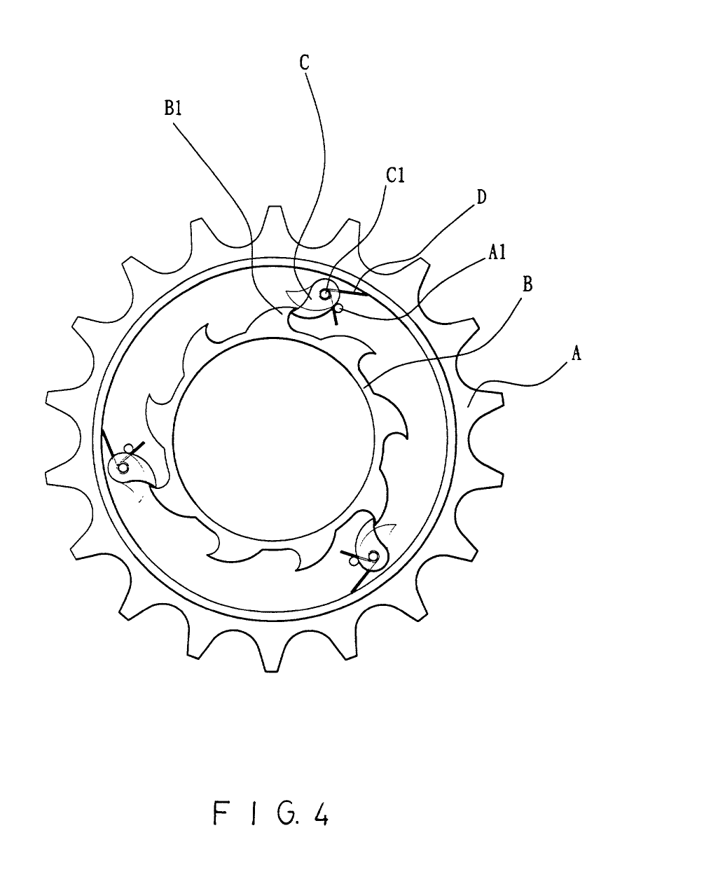

### DETAILED DESCRIPTION OF THE PREFERRED EMBODIMENT

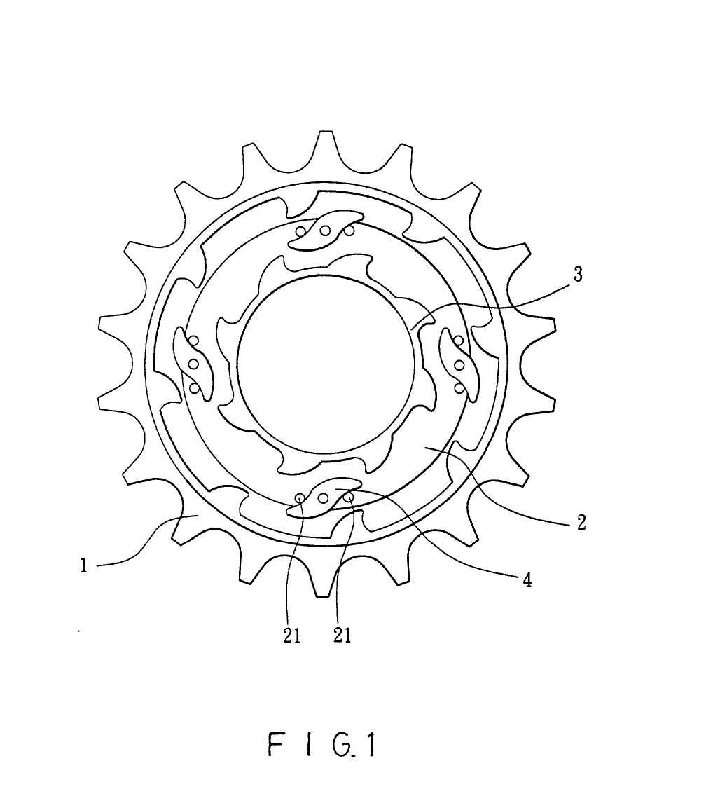

Referring to FIG. 1 a frictionless rear hub sprocket and ratchet assembly in accordance with the present invention is shown comprised of a sprocket 1, a wheel 2, a ratchet 3, and a plurality of pawls 4. The sprocket 1 is fastened to the rear hub of a bicycle and coupled to the chain on the chain wheel of the bicycle (not shown), comprising a plurality of internal teeth 11 equiangularly spaced around the inner diameter thereof. The wheel 2 is concentrically disposed within the inner diameter of the sprocket 1, comprising pairs of stop elements 21 equiangularly disposed at one side around the border area thereof. The ratchet 3 has an outer diameter smaller than the outer diameter of the wheel 2, comprising a plurality of external teeth 31 equiangularly spaced around the periphery and sloping in one direction. The center hole of the ratchet 3 fits the rear wheel axle of the rear wheel of the bicycle. The pawls 4 are respectively pivoted to the wheel 2 at one side by a respective pivot 41, each having a first end 411 and a second end 412.

When the sprocket 1 does no work (receives no power) as shown in FIG. 1, the pawls 4 are stopped by the stop elements 21, and the ends 411 and 412 of the pawls 4 do not touch the external teeth 31 of the ratchet 3 and the internal teeth 11 of the sprocket 1, therefore the ratchet wheel 3 can be freely rotated without causing noise or friction. If the sprocket 1 is driven to rotate clockwise, the internal teeth 11 of the sprocket 1 do not drive the pawls 4 to move the wheel 2, therefore the ratchet 3 can be rotated freely without causing noise or friction (see FIG. 1). If the sprocket 1 is driven to rotate counter-clockwise, the internal teeth 11 are forced against the second end 412 of each pawl 4, causing the first end 411 of each pawl 4 to engage the external teeth 31 of the ratchet 3, therefore the ratchet 3 and the sprocket 1 are engaged together for synchronous rotation, i.e., the ratchet 3 is rotated with the sprocket 1 counter-clockwise. When releasing the external force from the sprocket 1, the ratchet 3 is stopped from rotation.

In the aforesaid operation mode, the sprocket 1 is driven by the chain (not shown) to rotate the ratchet 3. Alternatively, the ratchet 3 can be driven to rotate the sprocket 1. Under this ratchet driving mode, the pawls 4 are stopped by the stop elements 21 to prevent contact of the ends 411 and 41 with the external teeth 31 and the internal teeth 11 if the ratchet 3 does no work (receives no power), therefore the sprocket 1 can be freely rotated without causing noise or friction. If the ratchet 3 is driven to rotate counter-clockwise, the external teeth 31 do not drive the first end 411 of each pawl 4, and the second end 412 of each pawl 4 does not engage the internal teeth 11 of the sprocket 1, therefore the sprocket 1 can be freely rotated without causing noise or friction.

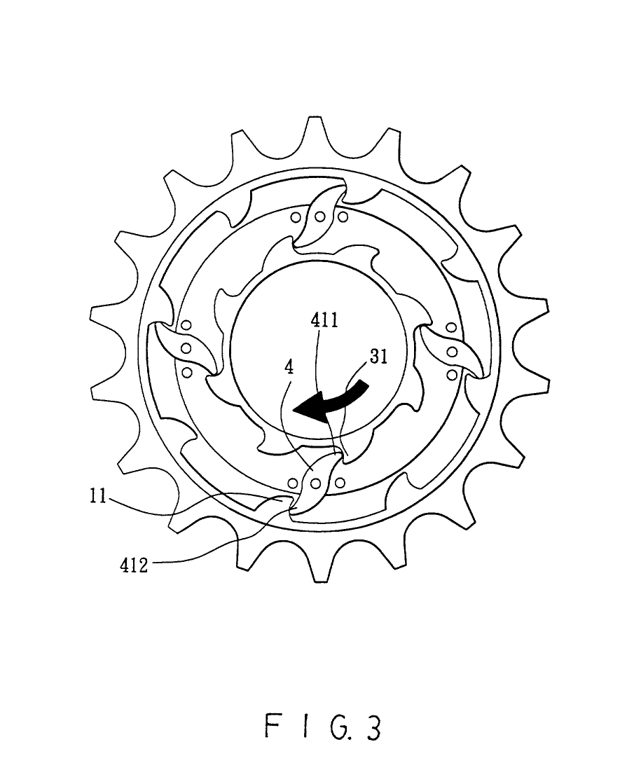

Referring to FIG. 3, if the ratchet 3 is driven to rotate clockwise, the external teeth 31 of the ratchet 3 are forced against the first e3nd 411 of each pawl 4, causing the pawls 4 to be turned in one direction to force the second end 412 of each pawl 4 into engagement with the internal teeth 11 of the sprocket 1, and therefore the sprocket 1 and the ratchet 3 are engaged together for synchronous rotation, i.e., the sprocket 1 is rotated clockwise with the ratchet 3. When releasing the external force from the ratchet 3, the sprocket 1 is stopped from rotation.

A prototype of frictionless rear hub sprocket and ratchet assembly has been constructed with the features of FIGS. 1˜4. The frictionless rear hub sprocket and ratchet assembly functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A frictionless rear hub sprocket and ratchet assembly installed in the rear wheel of a bicycle and coupled to the chain on the chain wheel of the bicycle, comprising:
a sprocket fastened to the rear hub of the bicycle and coupled to the chain on the chain wheel of the bicycle, said sprocket comprising an inner diameter and a plurality of internal teeth equiangularly spaced around an inner diameter thereof;
a wheel concentrically disposed within the inner diameter of said sprocket, said wheel comprising pairs of stop elements equiangularly disposed at one side around the border thereof;
a ratchet mounted on the rear wheel axle of the rear wheel of the bicycle, said ratchet having an outer diameter smaller than the outer diameter of said wheel, and a plurality of external teeth equiangularly spaced around the periphery thereof and sloping in one direction; and
a plurality of pawls respectively pivoted to said wheel at one side by a respective pivot and respectively disposed between the two stop elements of each pair of the stop elements of said wheel, said pawls each having a first end facing the external teeth of said sprocket and a second end facing the internal teeth of said sprocket;
wherein when said sprocket does no work or is rotated clockwise, or when said ratchet does no work or is rotated counter-clockwise, the first end and second end of each of said pawls do not engage the internal teeth of said sprocket and the external teeth of said ratchet, and said sprocket and said ratchet can be respectively rotated relative to each other; when said sprocket is rotated counter-clockwise or said ratchet is rotated clockwise, the first and second ends of each of said pawls are respectively forced into engagement with the internal teeth of said sprocket and the external teeth of said ratchet, causing said ratchet and said sprocket to be rotated synchronously.
